(19) United States
(12) Patent Application Publication
(10) Pub. No.: US 2009/0079365 A1
(43) Pub. Date: Mar. 26, 2009

(54) CONTROL METHOD AND BALLAST FOR RUN-UP OF METAL HALIDE LAMP

(75) Inventors: Nancy H. Chen, North Andover, MA (US); Joseph A. Olsen, Gloucester, MA (US)

Correspondence Address: OSRAM SYLVANIA INC, 100 ENDICOTT STREET, DANVERS, MA, 01923, US

(73) Assignee: OSRAM SYLVANIA INC., Danvers, MA (US)

(21) Appl. No.: 11/860,759

(22) Filed: Sep. 25, 2007

(51) Int. Cl. H05B 41/36

(52) U.S. Cl. 315/307

(57) ABSTRACT

A method of controlling run-up of a metal halide lamp that has a nominal (full) light output during steady state operation and that has a current limit Iₗᵢₘ, includes a lamp ballast sensing lamp current and voltage and calculating power, and evaluating requested power P_{req} and requested current I_{req} to operate the lamp at the nominal light output during run-up to steady state operation, supplying Iₗᵢₘ to operate the lamp when I_{req}≧Iₗᵢₘ, and supplying P_{req} to operate the lamp when I_{req}<Iₗᵢₘ. The method may determine P_{req} in various ways, including determining a light output L of the lamp; comparing lamp voltage to a nominal voltage Vₙ for the lamp during steady state operation; determining energy E delivered to the lamp; and estimating lamp efficacy. The method may also be used to characterize an unknown lamp attached to the ballast.

### BACKGROUND OF THE INVENTION

The present invention is related to the invention described in copending application Attorney Docket No. 2007P20037US, filed concurrently herewith and titled FAST RUN-UP OF METAL HALIDE LAMP BY POWER MODULATION AT ACOUSTIC RESONANCE FREQUENCY which is incorporated herein by reference.

The present invention is directed to a method of decreasing the time from ignition to nominal (full) light output of a metal halide lamp.

Metal halide lamps for general lighting are efficient and produce high quality white light. However, the lamps require a few minutes to warm up to nominal light output because ballast output is focused mainly on steady-state operation. Shorter times to nominal light output would improve the applicability of metal halide lamps.

A faster run-up to steady state lamp operation can be achieved by overpowering a cold lamp. A temporarily high power level is not necessarily a problem, but because a cold lamp also tends to have a very low voltage, an excessively high current would be required to achieve the power needed (power=voltage×current). Moreover, care must be taken because excessive power or current can lead to thermal shock, electrode damage, and wall blackening, and lamps typically have a current limit during run-up to avoid these problems. Thus, light output does not reach nominal as quickly as desired.

### SUMMARY OF THE INVENTION

An object of the present invention is to provide a novel method and ballast that shortens the time to nominal light output without damaging the lamp.

A yet further object of the present invention is to provide a novel method of controlling run-up of a metal halide lamp that has a nominal light output during steady state operation and that has a current limit Iₗᵢₘ, where the method includes sensing lamp current and voltage and calculating power, and evaluating requested power P_{req} and requested current I_{req} to operate the lamp at or near the nominal light output during the run-up to steady state operation, supplying Iₗᵢₘ to operate the lamp when I_{req} is greater than or equal to Iₗᵢₘ, and supplying P_{req} to operate the lamp when I_{req} is less than Iₗᵢₘ.

Another object of the present invention is to provide a novel ballast that carries out this method.

Yet another object of the present invention is to provide alternatives for determining when to switch from specifying lamp current to specifying lamp power, and how to adjust the power to maintain the nominal light output.

Still another object of the present invention is to use the method to characterize an unknown lamp attached to the ballast.

These and other objects and advantages of the invention will be apparent to those of skill in the art of the present invention after consideration of the following drawings and description of preferred embodiments.

### BRIEF DESCRIPTION OF THE DRAWINGS

FIG. 1 is a graph of normalized lamp efficacy vs. energy delivered to the lamp.

FIG. 2 is a graph of V, V′(E) and normalized lamp efficacy η vs. energy showing the derivative peak at about η=0.4.

FIG. 3 is a flow chart summarizing the four alternatives for controlling lamp run-up.

FIG. 4 is a flow chart showing a process for determining characteristics of an unknown lamp.

### DESCRIPTION OF PREFERRED EMBODIMENTS

To achieve the objectives set forth above, the inventors have focused on lamp control immediately following ignition, wherein lamp operation starts with lamp current at the current limit for the lamp. As energy is deposited to the arc and the arc tube heats up, the voltage, power and efficacy gradually increase until the nominal light output is achieved with the current at the current limit. At this point, the lamp is moderately overpowered since it has not warmed to its operating temperature. As the lamp warms, efficacy increases to the steady state level and the power is correspondingly decreased to maintain a (nearly) constant nominal light output. Decreasing the power as the lamp warms following the time at the current limit allows the lamp to be at or near nominal light output during the latter part of the run-up to steady state, and thus provides near nominal light output sooner than conventional metal halide lamps, thereby improving their applicability.

More particularly, the method of controlling run-up of a metal halide lamp that has a nominal light output Lₙ during steady state operation and that has a current limit Iₗᵢₘ, includes the steps in which, during run-up of the metal halide lamp to steady state operation, lamp current I, voltage V, and power P are continuously sensed or calculated, and requested power P_{req} and requested current I_{req} for operating the lamp at the nominal light output Lₙ during the run-up are continuously evaluated. The current limit Iₗᵢₘ is supplied to the lamp so long as I_{req} is greater than or equal to Iₗᵢₘ and P_{req} is supplied to the lamp when I_{req} is less than Iₗᵢₘ. Supplying P_{req} during the latter part of the run-up (when I_{req} is less than Iₗᵢₘ) allows the lamp to be at or near nominal light output sooner than conventional metal halide lamps. The reference to “continuous” herein includes both analog signals and digital sampling.

The method may be carried out by a program embodied in a ballast, such as a conventional electronic ballast.

The method includes four alternatives for determining when to switch from specifying lamp current to specifying lamp power, and how to adjust the power to maintain the nominal light output.

The first alternative provides that, during the run-up to steady state, a light output L of the lamp is continuously determined, where P_{req} is a function of L. More specifically, the method may provide that

P_{req}P* Lₙ/L, and

I_{req}I*P_{req}/P.

A photodiode may be used to measure L and appropriate conventional components may be provided so that the signal level is proportional to the lumen output of the lamp. Lamp power is scaled proportionally to Lₙ (steady state) divided by L to provide P_{req}. Lamp current is scaled proportionally to P_{req} divided by P to provide I_{req}.

This alternative decreases the time to nominal light output, although it may be less suitable than the alternatives discussed below in the event additional hardware (e.g., the photodiode) is cumbersome or dust may degrade signal reliability. In the other alternatives, feedback based on electrical parameters (voltage, energy delivered to the lamp, or lamp efficacy) is used.

The second alternative includes determining a nominal voltage Vₙ for the lamp during steady state operation, where P_{req} is a function of V and Vₙ. More specifically, the method may include determining a control coefficient C and a nominal power Pₙ for the lamp during steady state operation, wherein

P_{req}=Pₙ*(1+C*(Vₙ−V)/Vₙ), and

I_{req}I*P_{req}/P.

Voltage is an indicator of the lamp state, as cold lamps generally have a low voltage. Knowing the steady state lamp voltage, determining voltage during run-up and determining C by experimentation (e.g., on a similar lamp), permits formulation of power control algorithms based on voltage, of which the equation above is an example. The requested power is estimated by multiplying the nominal power by a factor that is dependent on the fractional deviation from nominal voltage and the control coefficient.

The second alternative also decreases the time to nominal light output, but may be less suited than the subsequent alternatives because as lamps age and among similar lamps the nominal voltage may vary, perhaps requiring some adjustment of the control parameters Vₙ and C. Voltage scatter among lamps and voltage drift may be caused by chemical fill variations, which may be the result of inconsistent doping, impurities, and aging reactions.

The last two alternatives are more robust than the third alternative because they are based on energy and power which are based on thermal properties of the lamp that tend to be more constant than lamp voltage.

The third alternative is based on energy delivered to the lamp and includes determining warm-up energy E_{w} delivered to the lamp when the lamp reaches nominal light output, and determining, during the run-up to steady state, energy E delivered to the lamp, where P_{req} is a function of E and E_{w}. More specifically, the method includes determining a power decay coefficient τ for the lamp, and, during run-up to steady state,

if E<E_{w}, then I_{req}=Iₗᵢₘ, and

if E≧E_{w}, then P_{req}=Pₙ+(P−Pₙ)*exp(−Δt/τ) and I_{req}=I*P_{req}/P,

wherein Δt is the time elapsed per feedback loop control.

The third alternative runs the lamp at the current limit until a specified amount of energy is delivered by the ballast, with the lamp being sufficiently warmed to reach nominal light output when the specified amount of energy has been delivered. As the lamp warms further, efficacy increases and power is decreased to the steady state level. An exponential reduction of the power with time has been found to work reasonably well producing a level nominal light output while the power is reduced. Thus, the control parameters are warm-up energy and the power decay coefficient.

In the third alternative warm-up energy E_{w} decreases with allowed run-up current (the limit current Iₗᵢₘ), since a higher run-up current means higher power levels during run-up which means lower efficacies and less lamp heating are required to reach nominal light output. Higher run-up currents and correspondingly higher power input also require faster power decay coefficients in order to produce the desired light output. Thus, the third alternative is reasonably stable against voltage variation, although the control parameters should be adjusted for different run-up currents. Nevertheless, for a given lamp with a specified current limit, the proper coefficients can be determined to provide consistent light output during run-up.

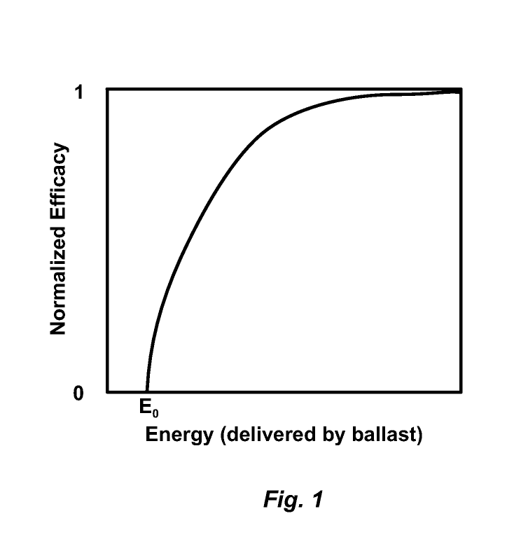

The fourth alternative includes approximation of the normalized lamp efficacy as a function of energy delivered to the ballast. The normalized lamp efficacy is assumed to range from approximately zero to one at steady state operation. It has been observed that for a number of lamps the normalized efficacy (ignoring dependence on instantaneous power) versus ballast energy can be approximated as an exponential, characterized by a coefficient E₁ and perhaps with an offset E₀. This is shown in FIG. 1.

That is, the fourth alternative includes determining a function of normalized lamp efficacy η vs. energy E delivered to the lamp, and, during the run-up to steady state, determining E and estimating η from the function, wherein

P_{req}Pₙ/η, and

I_{req}I*P_{req}/P.

The function by which lamp efficacy η is estimated may be

for E≧E₀, η=1−exp(−(E−E₀)/E₁), and

for E<E₀, η=0,

where E₀ and E₁ are constants which describe η(E). The function may be stored in a table in a memory in the ballast.

If E₀ and E₁ are specified, then the normalized lamp efficacy can be approximated at times during the run-up, and the requested power P_{req} is the nominal power divided by the normalized lamp efficacy.

For example, if at some point during the run-up the normalized lamp efficacy is 0.5, then the lamp power should be twice the nominal level. Of course, at the beginning of the run-up the current limit may control so the lamp power may not be attainable.

One advantage of the fourth alternative over the previous alternatives is that for a given lamp design, a single set of parameters E₀ and E₁ can generally be found to give reasonable run-up results independent of the current limit. The better the approximation of normalized efficacy, the more “ideal” the light output versus time (less deviation from Lₙ). Errors in approximation at the beginning of the run-up are less significant because the requested power will likely be limited by the current limit.

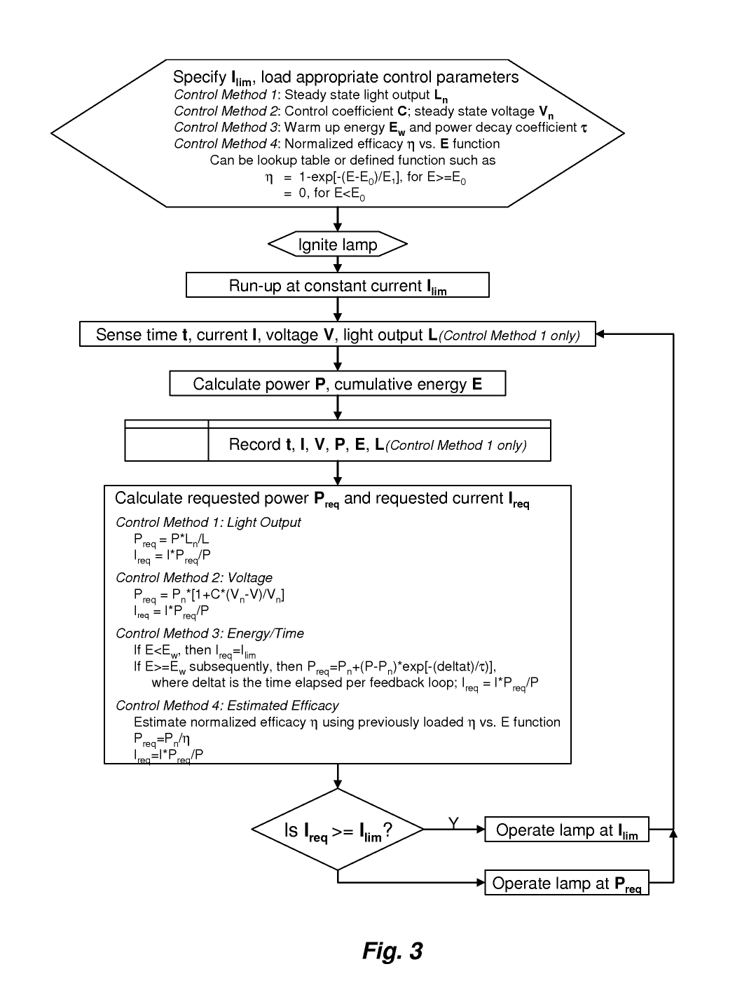

The four alternatives are summarized in the flowchart of FIG. 3.

One of the byproducts of the method of the present invention is that it can be used in a “smart” ballast to determine the characteristics of an unknown lamp to which the ballast is attached. That is, the method can be used in a standard ballast that is usable with various lamps, with the ballast itself figuring out how to apply current and power to reduce the time to nominal light output.

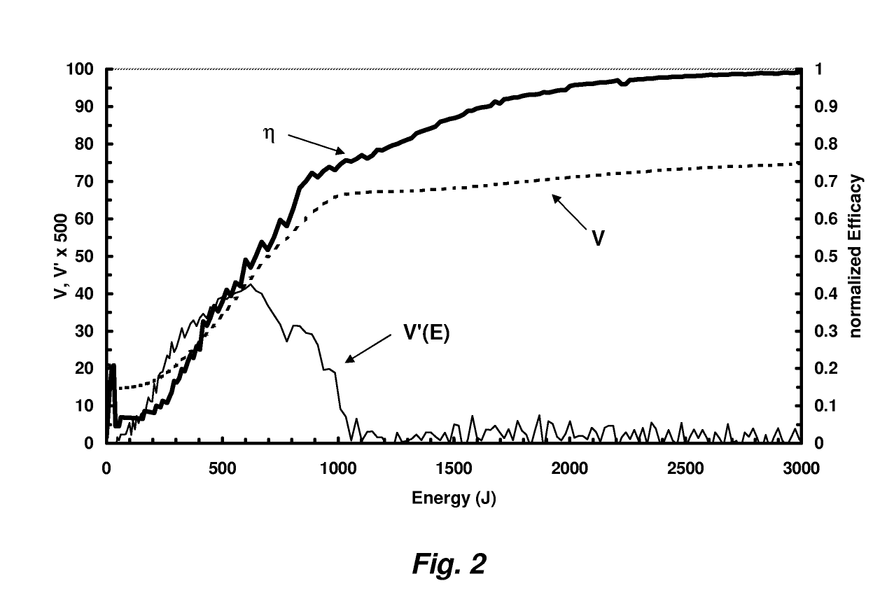

It has been observed that the derivative of voltage with respect to energy (V′(E)) delivered to the lamp reaches a peak during the run-up, with the corresponding normalized lamp efficacy at this time being about 0.3 to 0.5. FIG. 2 is a graph of V, V′(E) and normalized lamp efficacy η vs. energy showing the derivative peak at about η 0.4.

The peak in V′(E) is likely related to the evaporation process of the mercury dose, but an exact explanation is not needed in order to apply the results. For now, it is assumed that when V′(E) reaches a peak, the normalized lamp efficacy η is 0.4. Experimental determination of the energy at which V′(E) reaches its peak can be used to fit the equation given above and repeated below

η=1−exp(−(E−E₀)/E₁).

From this, a value of E₁ can be estimated if a value of E₀ is assumed. Since E₁ represents a thermal characteristic of the lamp and is generally higher for higher wattage lamps, the estimate of E₁ can be used to estimate the rated wattage. In other words, a ballast can be programmed to determine E₁ and then identify the lamp. Once the lamp is known, the correct nominal steady state power is known and the run-up light output versus time can be controlled as explained above.

When an unknown lamp is attached to the ballast, care must be taken to avoid excessive current, as discussed in the beginning of this document. One could use low starting currents, but this would increase the time to nominal light output. Currents that are too low can also cause excessive wall blackening due to electrode sputtering. This problem can be addressed by controlling the current so that the initial current is low enough for a range of lamp types, say about 0.5 A so that electrodes as small as 20 W would not be damaged. Thereafter, if the maximum V′(E) is not detected after a certain amount of energy is delivered, thereby indicating that E₁ is larger than for a 20 W lamp, then the current limit could be increased to a level suitable for a next larger lamp, say to about 1.0 A for a 35 W lamp. As subsequent E₁ thresholds are passed, the run-up current could be increased incrementally until the rate lamp power is finally identified. Alternatively, a controlled ramping up of the current may be used instead of the incremental steps just mentioned.

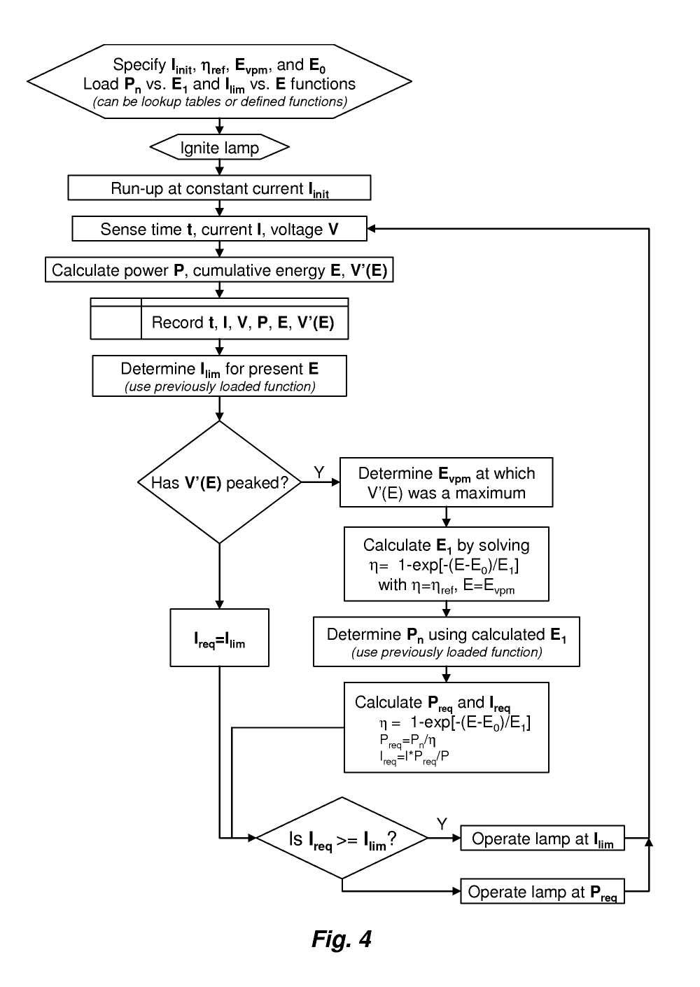

This embodiment is summarized in the flowchart of FIG. 4.

While embodiments of the present invention have been described in the foregoing specification and drawings, it is to be understood that the present invention is defined by the following claims when read in light of the specification and drawings.

We claim:

1. A method of controlling run-up of a metal halide lamp that has a nominal light output Lₙ during steady state operation and that has a current limit Iₗᵢₘ, the method comprising the steps of:
during run-up of the metal halide lamp to steady state operation, continuously sensing lamp current I and voltage V and calculating power P, and continuously evaluating requested power P_{req} and requested current I_{req} to operate the lamp at the nominal light output Lₙ during the run-up;
supplying Iₗᵢₘ to operate the lamp so long as I_{req}≧Iₗᵢₘ; and
supplying P_{req} to operate the lamp when I_{req}<Iₗᵢₘ.

2. The method of claim 1, further comprising the step of, during the run-up, continuously determining a light output L of the lamp, and wherein P_{req} is a function of L.

3. The method of claim 2, wherein
P_{req}P*Lₙ/L, and
I_{req}I*P_{req}/P.

4. The method of claim 1, further comprising the step of determining a nominal voltage Vₙ for the lamp during steady state operation, and wherein P_{req} is a function of V and Vₙ.

5. The method of claim 4, further comprising the step of determining a control coefficient C and a nominal power Pₙ for the lamp during steady state operation, and wherein
P_{req}=Pₙ*(1+C*(Vₙ−V)/Vₙ), and
I_{req}I*P_{req}/P.

6. The method of claim 1, further comprising the steps of determining warm-up energy E_{w} delivered to the lamp when the lamp reaches the nominal light output, and determining, during the run-up, energy E delivered to the lamp, and wherein P_{req} is a function of E and E_{w}.

7. The method of claim 6, further comprising the steps of determining a power decay coefficient τ for the lamp, and, during the run-up,
if E<E_{w}, then I_{req}=Iₗᵢₘ, and
if E≧E_{w}, then P_{req}=Pₙ+(P−Pₙ)*exp(−Δt/τ), and I_{req}=I*P_{req}/P
wherein Δt is the time elapsed per feedback loop control.

8. The method of claim 1, further comprising the step of, during the run-up, estimating lamp efficacy, and wherein P_{req} is a function of lamp efficacy.

9. The method of claim 1, further comprising the steps of determining a function of normalized lamp efficacy η vs. energy E delivered to the lamp, and, during the run-up, determining E and estimating η from the function, and wherein
P_{req}Pₙ/η, and
I_{req}I*P_{req}/P.

10. The method of claim 9, wherein the function is stored in a table in a memory in a ballast that operates the lamp.

11. The method of claim 9, wherein the function is
for E≧E₀, η=1−exp(−(E−E₀)/E₁), and
for E<E₀, η=0,
where E₀ and E₁ are constants which describe η(E).

12. The method of claim 1, further comprising the steps of,
determining values for normalized lamp efficacy η and energy E delivered to the lamp when a derivative of lamp voltage V′(E) is at a peak during the run-up,
assigning a value for E₀,
determining a value of E₁ from η=1−exp(−(E−E₀)/E₁),
estimating characteristics of the lamp from the determined value of E₁.

13. A ballast for a metal halide lamp that has a nominal light output Lₙ during steady state operation and that has a current limit Iₗᵢₘ, said ballast embodying a program that causes the ballast to control run-up of the metal halide lamp to steady state operation, the program causing the ballast to perform the steps of:
during run-up of the metal halide lamp to steady state operation, continuously sensing lamp current I and voltage V and calculating power P, and continuously evaluating requested power P_{req} and requested current I_{req} to operate the lamp at the nominal light output Lₙ during the run-up;
supplying Iₗᵢₘ to operate the lamp so long as I_{req}≧Iₗᵢₘ; and
supplying P_{req} to operate the lamp when I_{req}<Iₗᵢₘ.
